(19) United States
(12) Patent Application Publication
(10) Pub. No.: US 2004/0122919 A1
(43) Pub. Date: Jun. 24, 2004

(54) Method for Carrying out an Update in a Program-Controlled Device, Program-Controlled Device, and Program Code that can be Executed in a Web Browser

(75) Inventor: Rudiger Theis, Wulfrath (DE)

Correspondence Address: GUDRUN E. HUCKETT, LONSSTR. 53, WUPPERTAL, 42289, DE

(73) Assignee: WIESEMANN AND THEIS GMBH, Wuppertal (DE)

(21) Appl. No.: 10/604,823

(22) Filed: Aug. 20, 2003

Related U.S. Application Data
(63) Continuation of application No. PCT/EP02/01365, filed on Feb. 9, 2002.

(30) Foreign Application Priority Data
Feb. 20, 2001 (DE) 101 08 142.1

(51) Int. Cl. G06F 15/16; G06F 15/177

(52) U.S. Cl. 709/220; 709/218

(57) ABSTRACT

In an update method for a program in a program-controlled device, having a network connector, Web server functions, and being accessible via a Web browser, the device requests update information for a program update from a Web server. The update information is downloaded from the Web server on the device and transferred by the device to the Web browser. The update information is cached by a program code executable in the Web browser and then programmed into the device by the program code. The program-controlled device has a network connector to a Web server, an interface to a Web browser, and Web functions for downloading update information from the Web server and transferring it to the Web browser. A stored program code executable in the connected Web browser and at least one program changeable by the program code with the update information transferred to the Web browser are provided.

### CROSS REFERENCE TO RELATED APPLICATIONS

This is a continuation of international application PCT/EP02/01365 having an international filing date of Feb. 9, 2002, not published in English under PCT Article 21(2), and now abandoned.

### BACKGROUND OF INVENTION

1. Field of the Invention

The invention relates to a method for performing an update of a program in a program-controlled device. The invention also concerns such a program-controlled device as well as a program code that is executable in a Web browser.

2. Description of the Related Art

Program-controlled devices are used in a plurality of applications, for example, for automatically performing any type of measurements. Instead of a direct operating option provided on the device itself, a connection to a standard Web browser can be provided via which a user can operate the device. For enabling communication with the Web browser, the device must have integrated therein the necessary functions of a Web server.

In the program-controlled devices it is expedient when the devices enable a so-called update for the programs used therein which updates allow program error elimination or integration of new functions or other actualization in an existing program.

It is known in practice to perform such updates by means of so-called tools which themselves contain the desired update information as well as a program for integrating the update information into a program of the device. The tool is executed by means of a personal computer (PC) which is connected to the device. Such tools, however, are platform-dependent, i.e., they can only be used exclusively with personal computers having a certain platform such as Windows, UNIX etc. For each platform it is therefore necessary to provide a separate tool. Moreover, the desired tools, when requested from a provider, are often not available or not up-to-date for certain devices or for certain programs within a device; also, the tools overall are non-uniform with respect to their handling and behavior.

In another available option for performing updates of program-controlled devices, the update information is available on the Web server for downloading. For such an update, first an update data file is downloaded from the Web server onto a local hard drive of a device with installed Web browser. Subsequently, an upload of the data stored on the hard drive of the device is performed into the program-controlled device. For both data transfers, the Web browser serves as an operating platform for the user. With this second update option, the general availability of always current update information can be ensured because the information must be made available only once centrally on the Web server. Moreover, the utilization is platform-independent by employing a Web browser for performing the update.

However, this method has also several disadvantages. On the one hand, the device provided with the Web browser requires a hard drive for saving the update information. Some future compact Web access devices (Web appliances) however will no longer have a hard drive and would therefore be excluded from using them for such updates. On the other hand, the user, when downloading the update file from the Web server onto the hard drive of the device as well as for uploading the update information from the hard drive onto the program-controlled device, is independently required to select a path and a filename. This can easily result in errors and faulty operations.

Accordingly, the known options for performing an update of programs in a program-controlled device are not satisfactory.

### SUMMARY OF INVENTION

It is an object of the invention to provide a method and a program-controlled device as well as a program code to be run in a browser which enable an improved update of a program in a program-controlled device.

This object is firstly solved according to the invention by means of a method for performing an update of a program in a program-controlled device, the device comprising a network connector and Web server functions and accessible by means of a Web browser, wherein the method comprises the following steps.

Requesting update information for a program of the device from a Web server through the device, initiated by means of the Web browser.

Downloading update information from the Web server onto the device.

Transferring the downloaded update information to the Web browser.

Intermediately storing the update information by means of a program code executable by the Web browser.

Programming the update information into the device by means of the program code executable by means of the Web browser.

Secondly, the object is solved for a program-controlled device according to the invention by a network connector via which a connection to a Web server can be generated; an access means to a Web browser via which the device can be operated by a user; Web functions for downloading an update file from a Web server upon request by the Web browser and for transferring an update file that has been received from the Web server to the Web browser; and at least one program that can be changed based on transferred update information by means of a program code executable by the Web browser.

Finally, the object is solved according to the invention by a program code executable in a Web browser and configured to cache update information received via a program-controlled device and to program the update information into a device.

The invention is based on the principle that the problems of the known update options can be prevented by using a program code executable in the Web browser. The Web browser can be integrated into any suitable device, for example, a personal computer or a separate Web access device.

A particular advantage of the invention is initially provided in that within the program code according to the invention that is executable in a Web browser all of the sequences required for the update can be automated. Accordingly, by means of the method, the device, and the program code according to the invention, for performing an update only minimal input data must be provided by the user so that only a minimal chance for failure or operating mistakes is present.

Since the program code that programs the update information into the device configured to be executable in a Web browser, the update can also be carried out, as in the second prior art option listed above, by means of a uniform program code and a uniform update information. Also, as a result of making available the update information on a Web server in accordance with the method and the program-controlled device according to the invention, a central availability of update information that is easily kept current and completely maintainable is provided wherein according to the invention the download from the server can be carried out via the device itself. The web server can be, for example, a server that is made available by the device manufacturer and is accessible via the Internet, but it can also be a server which is available for access by different devices within a company.

In contrast to the second listed known method, a hard drive is not needed in the device provided with the Web browser where initially the update file that is downloaded is to be stored because caching in a working memory is sufficient for a program code executable by the Web browser.

Finally, the invention enables the use of standard services such as Web browsers and firewalls so that the use of the invention and the safety precautions require only a minimal expenditure.

Advantageous configurations of the method according to the invention, of the program-controlled device according to the invention, and of the program code that is executable in a Web browser can be taken from the dependent claims.

In a preferred embodiment of the invention, the program code that is executable in the Web browser is a Java applet. In this connection, Java is an object-oriented programming language developed by the company Sun Microsystems while applet refers is a program designed such that it can be carried out within the frame of another different application. Java applets are the most common program codes executable in a Web browser because they fulfill high safety standards. These safety standards ensure inter alia that a Java applet can communicate within a Web browser exclusively with that server from which the Java applet has been received.

Accordingly, in a further preferred embodiment the program code executable in the Web browser is stored in the program-controlled device and is made available to the Web browser for an update, respectively. This enables, when using a Java applet or another program code that can be executed in a Web browser and has similar safety standards, a subsequent communication of the program code with the program-controlled device. As an alternative, the program code executable in the browser can be stored in the Web server and can be made available to the Web browser by means of the program-controlled device that is configured as a router. This is of interest primarily for devices with a small memory. In this case, for Java applets or similar applets a subsequent communication with the program-controlled device is possible. Storing a Java applet in the memory which is correlated with the Web browser or a direct transfer from the Web server to the Web browser is however excluded by the described safety precautions because the applet then cannot communicate with the program-controlled device.

Special problems occur when the network communication program of the program-controlled device is to be updated because any communication of the device with a Web browser and a Web server is carried out by means of this program, which also contains the Web server functions of the device. In this case, during programming of the update information into the device, the old network program can be carried out simultaneously in a second memory within the device; however, the memory must fulfill certain minimum requirements which are often undesirable. As an alternative, during programming an especially simple network protocol is advantageously used which requires only minimal space in the memory.

Preferably, for a uniform handling of all updates a simple transmission protocol, which can be executed in the browser, is used for programming the update information into the device by means of the program code. Within the TCP/IP (transmission control protocol/Internet protocol) protocol family, primarily the trivial file transfer protocol (TFTP) is suitable for this purpose. Such simple transfer protocols are not supported by standard browsers but are enabled only by the inventive programming of the update information by means of a separate program code which is executable in the browser.

Another problem when updating a network communication program in a device resides in that disturbances within the update process can result in inconsistent data within the device; in an extreme situation this can cause a subsequent permanent communication interruption. For this reason, it is suggested not to update a so-called boot block. The boot block comprises only minimal communication functions as well as the core programs for the update. In the second method according to the prior art, the HTTP (hypertext transfer protocol) based on TCP is used for the transfer of the update information from the hard drive to the device via the Web browser; HTTP does not fit into small boot blocks. This difficulty does not emerge when, according to the invention, a simplified protocol such as TFTP is used for programming the update information into the device by means of a program code which is executable in the Web browser.

For an increased malfunction resistance it is furthermore suggested that the program code executable in the Web browser and/or the device has a function which enables checking of completeness of the data transfer before programming of the update information into the device. If as a result of incomplete data a disruption of the Internet path between the device and the Web server is detected, the program code or the device can perform an error correction in that, for example, a renewed transfer is requested from the Web server. In the phase before programming the update information, disturbances in the Internet cause only waiting periods, but no damage, so that monitoring in this phase of the transfer is very advantageous.

Moreover, the risks of the update itself can be reduced greatly by the invention because the program code executed in the Web browser has saved a copy of the update information. When problems occur, this copy can be used as a base for error correction. The magnitude of the network spacing can be determined by the used by selecting its own location and can therefore be kept at a minimum.

As already mentioned, programming of the update information into the device and also a possibly required error correction can be realized with the method, the device, and the program code according to the invention in an extremely user-friendly way because the program code executable in the Web browser can be designed such that all processes occur automatically. With the exception of starting an update, any actions to be carried out by the user can be eliminated. However, an interactive update with input by the user into the Web browser is possible also.

### BRIEF DESCRIPTION OF DRAWINGS

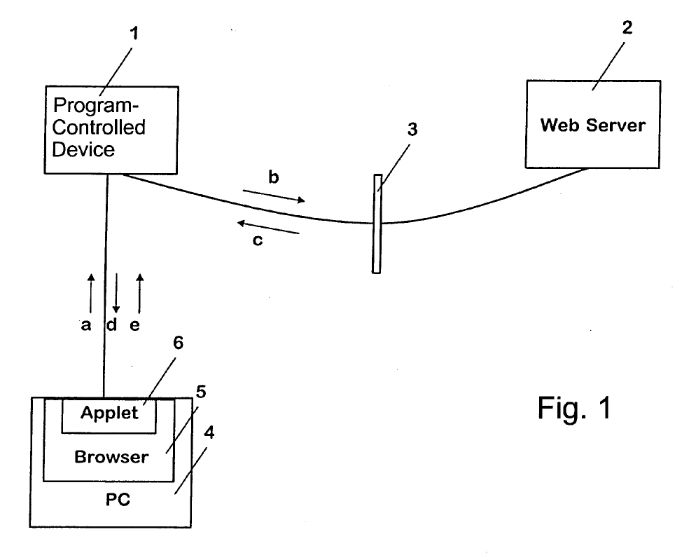

The invention will be explained in the following with the aid of the drawing showing one embodiment. The only FIG. 1 shows schematically the integration of a program-controlled device into an update system employing the method according to the invention.

### DETAILED DESCRIPTION

The program-controlled device 1 in FIG. 1 has a network connection by means of which it is connected to a Web server 2 via an Internet connection. The connection between the device and the Web server 2 extends through a firewall 3.

In addition, the device 1 is connected via a data line with a personal computer (PC) 4 in which a Web browser 5 is installed. In order for the device 1 to be able to communicate with the Web browser, it also comprises the required functions of a Web server.

During normal operation of the device 1 the connection to the Web server 2 is not present. The device is a measuring device which is configured to perform program-controlled measurements. The operation of the device 1 for presetting measurement parameters and for reading measurement results is realized by means of the Web browser 5 in the connected personal computer 4.

The method according to the invention is used when a program within the device 1 is to be updated. For example, this can be desirable when a program contains an error or when a new or improved version of the program is available. The device manufacturer of the device 1 provides, for actualization purposes of the program in the device 1, access to the Web server 2 on which the available update information for different programs is stored.

For initiating an update of the device 1, the user enters an update command via the Web browser 5 of the personal computer 4 with which, for example, the programs to be updated or possibly individual auxiliary functions of a program can be identified. As an alternative, it can also be provided that only a general update command is entered and that automatically all updates available for the device 1 are performed.

The Web browser 5 transfers the command by using HTTP to the device 1; this transfer is identified in the FIGURE by the letter a). The device 1 then contacts the Web server 2 as a HTTP client. The HTTP transfer b) for contacting enables in a known way passage of the firewall 3. The device 1 downloads the required update file also by means of HTTP transfer c) from the Web server 2 and transfers the obtained update file by using TFTP as a transfer means d) to the Web browser 5. Together with the update file, or at an earlier point in time, a Java applet is transferred to the Web browser 5; this Java applet is stored in the memory of the device 1. As an alternative, for the transfer b) to d) other types of protocols can be used.

The Java applet 6 is then started within the Web browser 5. As a first action it initiates caching of the update file in the working memory of the PC 4. Already during caching, the applet 6 checks also the completeness of the update file received in the personal computer 4. Should an error indicate a disruption in the Internet path between the Web server 2 and the firewall 3, the Java applet 6 requests via the device 1 a new transfer from the Web server 2.

As soon as the update file has been completely received and cached, the update can be performed automatically by the Java applet 6. For this purpose, the update information is programmed into the device 1 by means of the Java applet 6 by using TFTP. The transfer of the required data from the Java applet 6 to the device 1 is illustrated in FIG. 1 by e). The use of the simple TFTP protocol enables also an update of the network communication program.

In the case that during programming of the update information into the device 1 an error occurs, the Java applet 6, based on the cached copy of the update file (if needed, after performing an error elimination mechanisms contained within the Java applet 6), carries out a repeat of the programming steps so that, in combination with the initial control of the update file, a high safety with respect to uncorrectable programming errors is provided.

Since the device comprises a network connector as well as a network communication program and since the updates, by means of the connected Web browser 5, take place directly via the network, additional data input interfaces on the device 1 are obsolete with the exception of those that are needed for the standard operation of the device 1.

While specific embodiments of the invention have been shown and described in detail to illustrate the inventive principles, it will be understood that the invention may be embodied otherwise without departing from such principles.

What is claimed is:

1. A method for performing an update of a program in a program-controlled device that comprises a network connector and has Web server functions and is accessible via a Web browser, wherein the method comprises the steps of:
requesting with the device, initiated by the Web browser, update information for an update of a program of the program-controlled device from a Web server;
downloading the update information from the Web server on the program-controlled device;
transferring the update information downloaded on the program-controlled device by the program-controlled device to the Web browser;
caching the update information by a program code executable in the Web browser; and
programming the update information into the program-controlled device by the program code executable in the web browser.

2. The method according to claim 1, wherein the program code executable in the Web browser is a Java applet.

3. The method according to claim 1, further comprising the steps of storing the program code executable in the Web browser in the program-controlled device and making available the program code to the Web browser by the program-controlled device for a duration of an update that is performed.

4. The method according to claim 1, further comprising the steps of storing the program code executable in the Web browser in a Web server and making available the program code to the Web browser by the program-controlled device.

5. The method according to claim 1, wherein trivial file transfer protocol (TFTP) is employed in the step of programming.

6. The method according to claim 1, further comprising the steps of checking with at least one of the program code executable in the Web browser and the program-controlled device at least one of completeness or error-freeness of the update information before the step of programming the update information into the program-controlled device and, when an error is detected, carrying out error elimination with at least one of the program code executable in the Web browser and the program-controlled device.

7. The method according to claim 1, wherein, in the step of programming the update information into the program-controlled device, a user inputthe scope of the program code executable in the Web browser is enabled.

8. A program-controlled device comprising:
a network connector for providing a connection to a Web server;
an interface for providing a connection with a Web browser;
Web functions enabling, upon request by a connected Web browser, downloading of update information from a connected Web server and transferring the update information downloaded from the connected Web server to the connected Web browser;
a stored program code executable in the connected Web browser; and
at least one program changeable by the program code executable in the connected Web browser with the update information transferred to the Web browser.

9. The program-controlled device according to claim 8, wherein the stored program code executable in the Web browser is made available to the connected Web browser for carrying out an update of the at least one program.

10. The program-controlled device according to claim 8, wherein the stored program code executable in the Web browser is a Java applet.

11. The program-controlled device according to claim 8, comprising means for checking at least one of completeness and error-freeness of the update information downloaded from the connected Web server before transferring the update information to the connected Web browser and for performing error elimination, when an error has been found, before transferring the update information to the connected Web browser.

12. A program code executable in a Web browser and configured to cache update information received via a program-controlled device and to program the update information that has been cached into the program-controlled device.

13. The program code according to claim 12 in the form of a Java applet.

14. The program code according to claim 12, configured to check the update information received via the program-controlled device for at least one of completeness and error-freeness and configured to perform error elimination, when an error has been found, before programming the update information into the program-controlled device.
